(19) United States
(12) Patent Application Publication
(10) Pub. No.: US 2025/0021836 A1
(43) Pub. Date: Jan. 16, 2025

(54) SELF-LEARNING OF RULES THAT DESCRIBE NATURAL LANGUAGE TEXT IN TERMS OF STRUCTURED KNOWLEDGE ELEMENTS

(71) Applicant: International Business Machines Corporation, Armonk, NY (US)

(72) Inventors: Shajith Ikbal Mohamed, Chennai (IN); Hima Prasad Karana, Bangalore (IN); Udit Sharma, Shimla (IN); Sumit Neelam, Agra (IN); Pavan Kapanipathi Bangalore, Westchester, NY (US); Ronny Luss, Glen Rock, NJ (US); Maxwell Crouse, Chicago, IL (US); SUBHAJIT CHAUDHURY, White Plains, NY (US); Achille Belly Fokoue-Nkoutche, White Plains, NY (US); Alexander Gray, Yonkers, NY (US)

(21) Appl. No.: 18/351,667

(22) Filed: Jul. 13, 2023

(51) Int. Cl. G06N 5/025

(52) U.S. Cl. CPC G06N 5/025

(57) ABSTRACT

A system can comprise a memory that stores computer executable components, and a processor, operably coupled to the memory, that executes the computer executable components comprising: a linking component that associates one or more unmasked elements of the logical form with one or more corresponding structured knowledge elements of a knowledge base and a prediction component that predicts the one or more masked elements based on extended context of the corresponding structured knowledge elements of the knowledge base to generate one or more predicted elements. In an embodiment, the prediction component predicts the one or more masked elements based on scores of one or more candidate elements. In an embodiment, the system can determine one or more rules that describe the natural language text segment in terms of the structured knowledge elements and associated weights of the knowledge base paths.

### BACKGROUND

The subject disclosure relates to knowledge acquisition, and more specifically, to knowledge acquisition associated with a structured knowledge base of an artificial intelligence system.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products in accordance with the present invention.

According to an embodiment, a system can comprise a memory that stores computer executable components and a processor that executes the computer executable components stored in the memory. The computer executable components can comprise a linking component that associates one or more unmasked elements of a logical form of a natural language text segment with one or more corresponding structured knowledge elements of a knowledge base. The computer executable components can further comprise a prediction component that predicts one or more masked elements of a logical form based on extended context of the one or more corresponding structured knowledge elements of the knowledge base to generate one or more predicted elements. Additional aspects of the present disclosure are directed to systems and computer program products configured to perform the methods described above.

### DESCRIPTION OF THE DRAWINGS

FIG. 1 illustrates a block diagram of an example, non-limiting system that can facilitate self-learning of rules for natural language text, in accordance with one or more embodiments described herein.

FIG. 2 illustrates a block diagram of an example, non-limiting system that can facilitate self-learning of rules for natural language text, in accordance with one or more embodiments described herein.

FIG. 3 illustrates a diagram of an example, non-limiting system that can facilitate self-learning of rules for natural language text, in accordance with one or more embodiments described herein.

FIG. 4 illustrates a diagram of an example, non-limiting system that can facilitate self-learning of rules for natural language text, in accordance with one or more embodiments described herein.

FIG. 5 illustrates a diagram of an example, non-limiting system that can facilitate self-learning of rules for natural language text, in accordance with one or more embodiments described herein.

FIG. 6 illustrates an example code that facilitates self-learning of rules for natural language text.

FIG. 7 illustrates a flow diagram of an example, non-limiting computer-implemented method in accordance with one or more embodiments described herein.

FIG. 8 illustrates a flow diagram of an example, non-limiting computer-implemented method in accordance with one or more embodiments described herein.

FIG. 9 illustrates a flow diagram of an example, non-limiting computer-implemented method in accordance with one or more embodiments described herein.

FIG. 10 illustrates a block diagram of an example, computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Knowledge acquisition is a key aspect for the successful completion of a task by artificial intelligence. To perform tasks, AI relies on a knowledge base comprising data such as objects, facts, relationships, and rules. The information in a knowledge base serves as the basis for AI decisions and responses to input. A knowledge base can comprise structured information that is organized to facilitate efficient information retrieval and reasoning. The structured information can comprise facts, definitions, rules, constraints, formulas, algorithms, and any other relevant knowledge elements. Available knowledge bases comprise knowledge in terms of relations among known concepts.

Knowledge bases of AI models can acquire additional knowledge over time. Growing a knowledge base can improve the performance of an associated AI system. To be useful to an AI, knowledge gained should be in a structured form in the knowledge base. Some current methods of knowledge acquisition utilize human defined rules or supervised black-box modeling. It is desirable that a system be able to self-learn rules that describe natural language segments in terms of existing structured knowledge.

By way of overview, aspects of systems apparatuses or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details. As used herein, the term “entity” can refer to a machine, device, component, hardware, software, smart device and/or human.

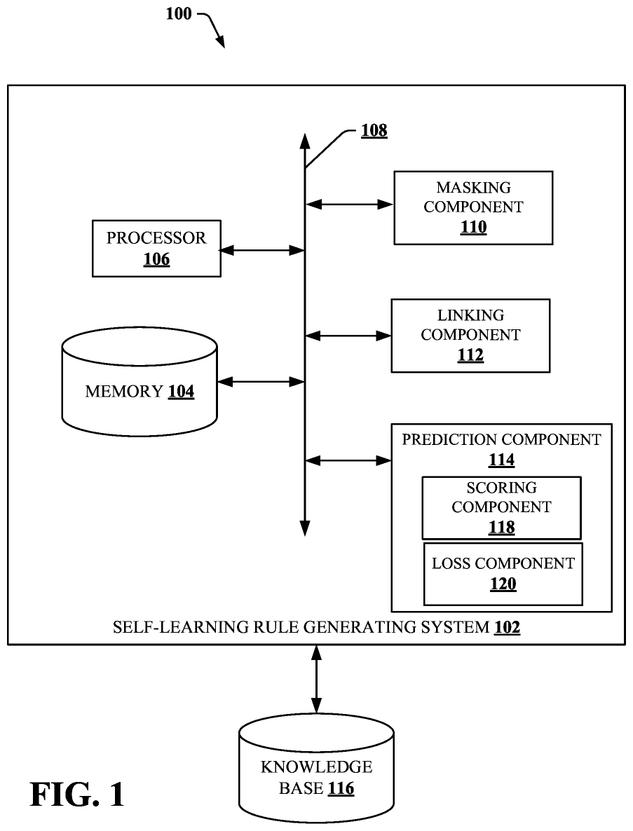

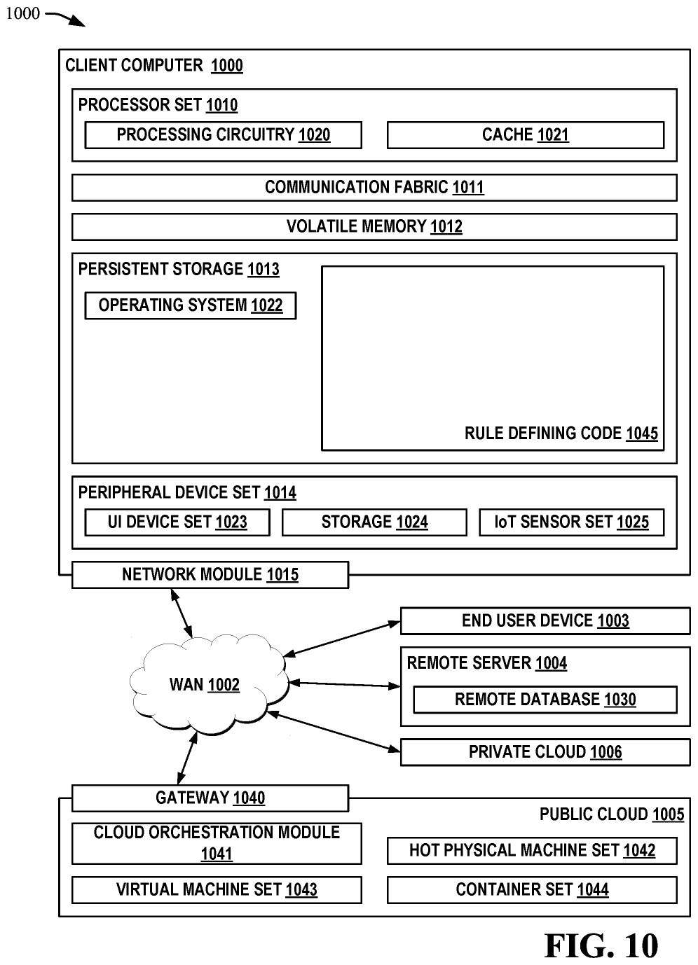

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100-500 as illustrated at FIGS. 1-5, and/or systems thereof, can further comprise, be associated with and/or be coupled to one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIGS. 1-5 and/or with other figures described herein.

FIG. 1 illustrates a block diagram of an example, non-limiting self-learning rule generating system 102 that facilitates self-learning of rules for natural language text in accordance with one or more embodiments described herein. As illustrated at FIG. 1, the self-learning rule generating system 102 can comprise one or more components, such as a memory 104, processor 106, bus 108, masking component 110, linking component 112, prediction component 114, knowledge base 116, scoring component 118, and/or loss component 120. In an embodiment, the system 102 is communicatively coupled to knowledge base 116. Generally, self-learning rule generating system 102 can facilitate self-learning of rule that describe natural language text segments in terms of structured knowledge elements.

Masking component 110 can receive a logical form of a natural language text segment. Masking component 110 can mask one or more elements of the logical form of a natural language text segment resulting in the one or more masked elements and one or more unmasked elements of the logical form. A logical form of a natural language text segment can take the form of, for example, a First-Order-Logic form, a Lambda calculus representation, an abstract meaning representation, a dependency graph, or another form. Various examples of embodiments presented herein refer to simple sentence natural language text segments that can be written in a single predicate triple logical form comprising a predicate, a source entity, and a destination entity. For example, the text segment “actor A shared the screen with actor B” comprises a source entity of “actor A”, a destination entity of “actor B” and a predicate of “shared the screen with.” The example text segment can be expressed in single predicate triple logical form as share-screen (‘actor A’, ‘actor B’).

Masking component 110 can mask one or more elements of a logical form by replacing the one or more elements of the logical form of a natural language text segment with masking characters or tokens. Masked elements are elements of the logical form that are replaced with masking characters or tokens for self-learning purposes. Unmasked elements are elements of the logical form that are not replaced with masking characters or tokens. For example, masking component 110 can mask the predicate of the example logical form above as MASK (‘actor A’, ‘actor B’). The masking component 110 can also mask a source entity and/or a destination entity. For example, the masking component 110 can mask the destination entity of the example logical form as share-screen (‘actor A’, MASK). Once masking component 110 has masked one or more elements of the logical form, the logical form consists of masked elements and unmasked elements.

Linking component 112 can associate one or more unmasked elements of the logical form with one or more corresponding structured knowledge elements of a knowledge base. For example, if a predicate is the only masked element in a single predicate triple logical form of a natural language text segment, the linking component 112 can associate the unmasked elements of the source entity and the destination entity with corresponding structured knowledge elements within the knowledge base. For example, the source entity ‘actor A’ can be associated with a structured knowledge element associated with actor A. For example, a structured knowledge element can be a node corresponding to an entity such as actor A. A structured knowledge element can also be a path connecting two or more nodes of a knowledge base. In an embodiment, an element of the logical from can correspond to and be associated with more than one structured knowledge element.

Prediction component 114 can predict the one or more masked elements based on extended context of the corresponding structured knowledge elements of the knowledge base to generate one or more predicted elements. Prediction component 114 can identify one or more contextual structured knowledge elements that are related to the one or more corresponding structured knowledge elements associated with the one or more unmasked elements. The one or more contextual structured knowledge elements can be identified by traversing the structured data of the knowledge base. For example, extended context can be contextual structured knowledge elements. For example, a contextual structured knowledge element can be a path connecting a structured knowledge element (e.g., a node) corresponding to an unmasked source entity and a structured knowledge element (e.g., a node) corresponding to an unmasked destination entity. In an embodiment, the extended context of the corresponding structured knowledge elements can comprise all paths between nodes corresponding to an unmasked source entity and an unmasked destination entity. The paths can include other intermediate structured knowledge elements, such as other nodes. For another example, a contextual structured knowledge element can be one or more nodes corresponding to one or more entities that are connected to a node corresponding to an unmasked source entity or an unmasked destination entity by paths corresponding to an unmasked predicate. In an embodiment, the extended context of the corresponding structured knowledge elements can comprise all nodes connected to one or more structured knowledge elements.

Scoring component 118 can calculate estimated scores corresponding to candidate predicted elements. In an embodiment, the prediction component 114 comprises scoring component 118. In an embodiment, the prediction component 114 can predict the one or more masked elements based on extended context of the corresponding structured knowledge element by identifying all contextual structured knowledge elements of the corresponding structured elements associated with the unmasked elements of the logical form. In an embodiment, the candidate predicted elements can be associated with a contextual structured knowledge element. In another embodiment, the candidate predicted elements can be pre-identified in the knowledge base. The scoring component can estimate a score corresponding to each candidate predicted element. The scores can be based on the contextual structured knowledge elements and their associated weights within the knowledge base.

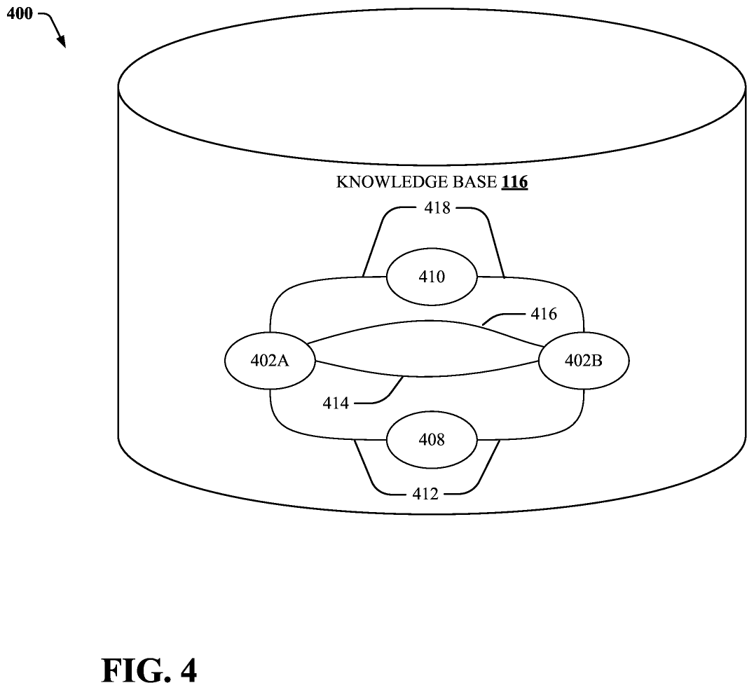

Consider an example wherein a natural language text segment is represented by a logical form P(se, de). The logical form can be masked so that the predicate is a masked element and the source entity and the destination entity are unmasked elements so that the masked logical form is MASK (se, de). With reference to FIG. 4, the source entity can correspond to structured knowledge element 402A and the destination entity can correspond to structured knowledge element 402B. In an embodiment, the prediction component 114 can identify the extended context of the corresponding structured knowledge elements 402A and 402B by traversing the structured data of the knowledge base. With reference to structured knowledge elements 402A and 402B, the extended context comprises structured knowledge elements (i.e., paths) KBP1 412, KBP2 416, KBP3 418, and KBP4 420, wherein KBP stands for knowledge base path. Each knowledge base path can be associated with a weight. KBP2 414 and KBP3 416 can define a direct relationship between structured knowledge elements 402A and 402B (i.e., a 0-hop path). KBP1 412 relates structured knowledge element 408 to corresponding structured elements 402A and 402B (i.e., a 1-hop path between 402A and 402B). KBP4 418 relates structured knowledge element 410 to corresponding structured elements 402A and 402B (i.e., a 1-hop path between 402A and 402B). Other possible knowledge base paths can be n-hop paths. A predicate can be associated with one or more rules. For example, where the source entity is “actor A”, the destination entity is “actor B”, and structured element 408 is associated with a film that both actor A and actor B performed in, a rule associated with the predicate “shared the screen with” can be represented as share-screen←w*(KBP1−&KBP1+) where w is a weight associated with the path.

The scoring component can calculate estimated scores corresponding to candidate predicted elements. For the above example, the candidate elements can be known predicates stored in the knowledge base. For instance, a score:

S=R_{{0:M}}^{T}P

for each candidate predicate:

$$\\ CP 1 ( se , de ) = OR ( {w}_{11} * KBP 1 ( se , de ) , {w}_{12} * KBP 2 ( se , de ) , {w}_{13} * KBP 3 ( se , de ) , {w}_{14} * KBP 4 ( se , de ) )$$

$$\\ CP 2 ( se , de ) = OR ( {w}_{21} * KBP 1 ( se , de ) , {w}_{22} * KBP 2 ( se , de ) , {w}_{23} * KBP 3 ( se , de ) , {w}_{24} * KBP 4 ( se , de ) )$$

$$\\ …$$

$$\\ CPm ( se , de ) = OR ( {w}_{m 1} * KBP 1 ( se , de ) , {w}_{m 2} * KBP 2 ( se , de ) , {w}_{m 3} * KBP 3 ( se , de ) , {w}_{m 4} * KBP 4 ( se , de ) )$$

$$\\ CPM ( se , de ) = OR ( {w}_{M 1} * KBP 1 ( se , de ) , {w}_{M 2} * KBP 2 ( se , de ) , {w}_{M 3} * KBP 3 ( se , de ) , {w}_{M 4} * KBP 4 ( se , de ) )$$

can be calculated.

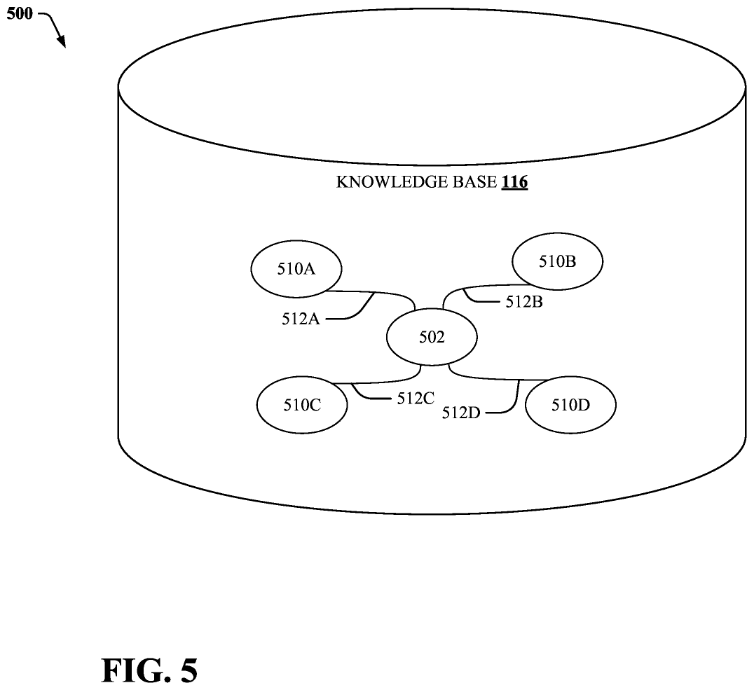

Consider another example wherein a natural language text segment is represented by a logical form P(se, de). The logical form can be masked so that the destination entity is a masked element and the predicate and the source entity are unmasked elements so that the masked logical form is P(se, MASK). With reference to FIG. 5, the destination entity can correspond to structured knowledge element 502 and the predicate can correspond to structured knowledge elements (i.e., paths) KBP1 512A, KBP2 512B, KBP3 512C, and KBP4 512D. In an embodiment, the prediction component 114 can determine the extended context of the corresponding structured knowledge elements 502 and 512A-D. With reference to structured knowledge elements 502 and 512A-D, the extended context comprises structured knowledge elements (i.e., nodes) e1 510A, e2 510B, e3 510C, and e4 510D. Each knowledge base path can be associated with a weight. 512A-D can define a direct relationship between structured knowledge elements 502 and structured knowledge elements 512A-D. In an embodiment, the paths corresponding to the predicate can comprise intermediary nodes. The structured knowledge elements 510A-D can correspond to candidate destination entities.

The scoring component can calculate estimated scores corresponding to candidate predicted elements. For example, a score can be calculated for each candidate destination entity (e1-e4) corresponding to the nodes of the extended context:

$$\\ CPm ( se , e 1 ) = OR ( {w}_{m 1} * KBP 1 ( se , e 1 ) , {w}_{m 2} * KBP 2 ( se , e 1 ) , {w}_{m 3} * KBP 3 ( se , e 1 ) , {w}_{m 4} * KBP 4 ( se , e 1 ) )$$

$$\\ CPm ( se , e 2 ) = OR ( {w}_{m 1} * KBP 1 ( se , e 2 ) , {w}_{m 2} * KBP 2 ( se , e 2 ) , {w}_{m 3} * KBP 3 ( se , e 2 ) , {w}_{m 4} * KBP 4 ( se , e 2 ) )$$

$$\\ CPm ( se , e 3 ) = OR ( {w}_{m 1} * KBP 1 ( se , e 3 ) , {w}_{m 2} * KBP 2 ( se , e 3 ) , {w}_{m 3} * KBP 3 ( se , e 3 ) , {w}_{m 4} * KBP 4 ( se , e 3 ) )$$

$$\\ CPm ( se , e 4 ) = OR ( {w}_{m 1} * KBP 1 ( se , e 4 ) , {w}_{m 2} * KBP 2 ( se , e 4 ) , {w}_{m 3} * KBP 3 ( se , e 4 ) , {w}_{m 4} * KBP 4 ( se , e 4 ) ) .$$

Consider another example wherein a natural language text segment is represented by a logical form P(se, de). The logical form can be masked so that the source entity is a masked element and the predicate and the destination entity are unmasked elements so that the masked logical form is P(MASK, de). With reference to FIG. 5, the source entity can correspond to structured knowledge element 502 and the predicate can correspond to structured knowledge elements (i.e., paths) KBP1 512A, KBP2 512B, KBP3 512C, and KBP4 512D. In an embodiment, the prediction component 114 can determine the extended context of the corresponding structured knowledge elements 502 and 512A-D. With reference to structured knowledge elements 502 and 512A-D, the extended context comprises structured knowledge elements (i.e., nodes) e1 510A, e2 510B, e3 510C, and e4 510D. Each knowledge base path can be associated with a weight. 512A-D can define a direct relationship between structured knowledge elements 502 and structured knowledge elements 512A-D. In an embodiment, the paths corresponding to the predicate can comprise intermediary nodes. The structured knowledge elements 510A-D can correspond to candidate source entities.

The scoring component can calculate estimated scores corresponding to candidate predicted elements. For example, a score can be calculated for each candidate source entity (e1-e4) corresponding to the nodes of the extended context:

$$\\ CPm ( e 1 , de ) = OR ( {w}_{m 1} * KBP 1 ( e 1 , de ) , {w}_{m 2} * KBP 2 ( e 1 , de ) , {w}_{m 3} * KBP 3 ( e 1 , de ) , {w}_{m 4} * KBP 4 ( e 1 , de ) )$$

$$\\ CPm ( e 2 , de ) = OR ( {w}_{m 1} * KBP 1 ( e 2 , de ) , {w}_{m 2} * KBP 2 ( e 2 , de ) , {w}_{m 3} * KBP 3 ( e 2 , de ) , {w}_{m 4} * KBP 4 ( e 2 , de ) )$$

$$\\ CPm ( e 3 , de ) = OR ( {w}_{m 1} * KBP 1 ( e 3 , de ) , {w}_{m 2} * KBP 2 ( e 3 , de ) , {w}_{m 3} * KBP 3 ( e 3 , de ) , {w}_{m 4} * KBP 4 ( e 3 , de ) )$$

$$\\ CPm ( e 4 , de ) = OR ( {w}_{m 1} * KBP 1 ( e 4 , de ) , {w}_{m 2} * KBP 2 ( e 4 , de ) , {w}_{m 3} * KBP 3 ( e 4 , de ) , {w}_{m 4} * KBP 4 ( e 4 , de ) )$$

A loss component 120 can determine a loss based on the estimated scores and target scores associated with the masked element. The loss component 120 can determine the loss by comparing the estimated scores (s1, s2, s3, s4) to target scores. For example, a target score can be 0 for a candidate destination entity that does not match the masked element and a target score can be 1 for a candidate destination entity that does match the masked element.

The prediction component 114 can predict an element for the masked element based on the comparison of the scores associated with the candidate elements and the target scores. In an embodiment, the prediction component 114 can output the logical form of the natural language text segment with the predicted element in the place of the masked element.

The various devices (e.g., system 100) and components (memory 104, processor 106, masking component 110, and/or other components) of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

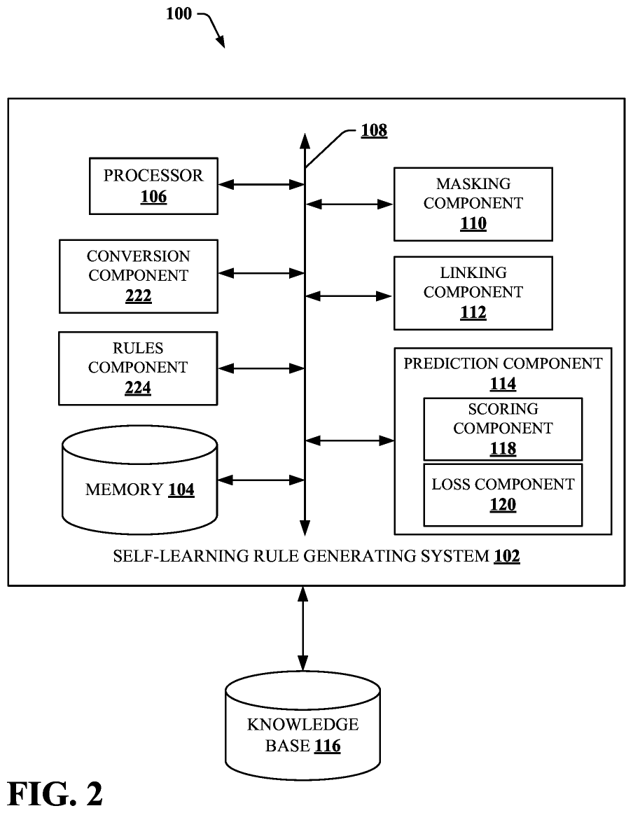

FIG. 2 illustrates a block diagram of an example, non-limiting system 200 that facilitates self-learning of rules for natural language text in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

The system 200 comprises a conversion component 222 that can convert the natural language text segment to the logical form. For example, the conversion component 222 can receive the text segment “actor A shared the screen with actor B” and convert it to the logical form share-screen (‘actor A’, ‘actor B’). Conversion component 218 can further convert natural language text segments into other logical forms, including but not limited to a First-Order-Logic form, a Lambda calculus representation, an abstract meaning representation, a dependency graph, or another form.

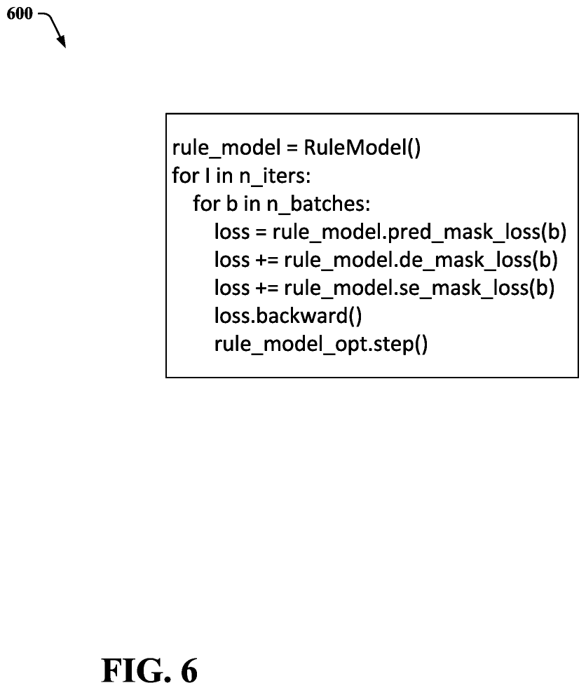

Rules component 224 can determine one or more rules that describe the natural language text segment in terms of the structured knowledge elements and associated weights of the knowledge base. As discussed above, the loss component 120 determines a loss for the predictions of the prediction component 114. The rules component 224 can, based on the loss, iteratively update the prediction model of the prediction component 114 associated with the knowledge base, to improve the accuracy of the predicted element. Updates to the prediction model can maximize or optimize the score for the masked element. In an embodiment, the prediction model can be updated based on a combined loss for each masked element. In another embodiment, the model can be updated based on a loss calculated for a single masked element. Any combination of losses associated with masked elements used to iteratively update a prediction model is envisioned. FIG. 6 illustrates an example training scheme for a model.

The rules component 224 can determine rules that describe natural language text segments in terms of the structured knowledge elements of a knowledge base based on self-learning. The rules component 224 determines rules that describe natural language text segments in terms of the structured knowledge elements by updating a prediction model and employing the updated prediction model on logical forms of natural language text segments. Rules component 224 can, for example, determine rules in terms of knowledge base elements for natural language predicates. For example, the predicate “book-write” can be mapped to example rules OR{(“KNP19+1”, “author”, 0.88), (“KNP800-1”, “notable work”, 0.87)}.

Rules component 224 can further apply learned rules to infer new facts from known facts in the knowledge base. The learning of new facts and rules can improve performance of an AI system. For example, an AI system may receive queries to be answered. Knowledge gained to the knowledge base through self-learning (such as rules and facts) can improve logical consistency and factual correctness of output of an associated AI model.

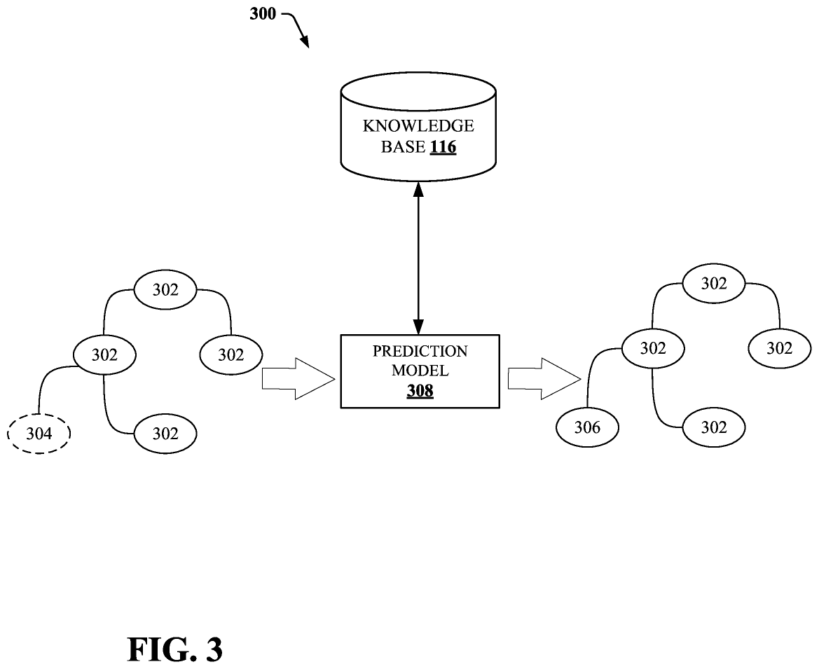

FIG. 3 illustrates an example, non-limiting system 300 that facilitates self-learning of rules for natural language text, in accordance with one or more embodiments described herein. Repetitive description of like elements and/or processes employed in respective embodiments is omitted for sake of brevity. As indicated previously, description relative to an embodiment of FIGS. 1-2 can be applicable to an embodiment of FIG. 3. Likewise, description relative to an embodiment of FIG. 3 can be applicable to an embodiment of FIGS. 1-2.

The system 300 illustrates the prediction of masked elements. Elements 302 and element 304 represent a logical form of a natural language text segment. The elements 302 represent unmasked elements of the logical form and the element 304 represents a masked element of the logical form. In an embodiment, the logical form can comprise one unmasked element 302 and/or multiple masked elements 304. Through prediction model 308, an output of a new logical form is generated. The new logical from comprises unmasked elements 302 and a predicted element 306. The predicted element 306 replaces the masked element 304. The system aims that predicted element 306 matched masked element 302. Through prediction model 308, the unmasked elements 302 are grounded to one or more structured knowledge elements within the knowledge base 116. Masked element 304 is not grounded to a structured knowledge element of the knowledge base 116. The predicted element 306 is grounded to one or more structured knowledge elements of the knowledge base 116.

FIG. 4 illustrates an example, non-limiting system 400 that facilitates self-learning of rules for natural language text, in accordance with one or more embodiments described herein. Repetitive description of like elements and/or processes employed in respective embodiments is omitted for sake of brevity. As indicated previously, description relative to an embodiment of FIGS. 1-3 can be applicable to an embodiment of FIG. 4. Likewise, description relative to an embodiment of FIG. 4 can be applicable to an embodiment of FIGS. 1-3.

The system 400 illustrates knowledge base 116 and associated structured knowledge elements. Knowledge base 116 can comprise one or more types of structured knowledge elements including but not limited to facts, definitions, rules, constraints, formulas, and algorithms. Structured knowledge elements can be in, for example, a neural framework. For example, knowledge base 116 can comprise 402A, 402B, 408, and 410 and paths 412, 416, 418, and 420. Elements of a logical form of a natural language segment can be mapped to or otherwise associated with structured knowledge elements of knowledge base 116.

For instance, for a logical form P(se, de), a predicate (P) can be mapped to one or more paths and/or nodes. The predicate can define a relationship between two or more entities (e.g., a source entity and a destination entity). A path that a predicate is mapped to can define a corresponding relationship between structured knowledge elements corresponding to other elements of the logical form, such as the source entity and the destination entity. For example, consider the logical form share-screen (‘actor A’, ‘actor B’). Suppose that the source entity “actor A” is mapped to structured knowledge element 402A and the destination entity “actor B” is mapped to a structured knowledge element 402B. The structured knowledge element 408 can represent a film that both actor A and actor B stared in. Therefore, the predicate share-screen can be defined by the relationships of relevant structured knowledge elements such as 402A, 402B, 408, and 412.

FIG. 5 illustrates an example, non-limiting system 500 that facilitates self-learning of rules for natural language text, in accordance with one or more embodiments described herein. Repetitive description of like elements and/or processes employed in respective embodiments is omitted for sake of brevity. As indicated previously, description relative to an embodiment of FIGS. 1-4 can be applicable to an embodiment of FIG. 5. Likewise, description relative to an embodiment of FIG. 5 can be applicable to an embodiment of FIGS. 1-4.

The system 500 illustrates knowledge base 116 and associated structured knowledge elements. Knowledge base 116 can comprise one or more types of structured knowledge elements including but not limited to facts, definitions, rules, constraints, formulas, and algorithms. Structured knowledge elements can be in a neural framework. For example, knowledge base 116 can comprise node 502, nodes 510A-D and paths 512A-D. Elements of a logical form of a natural language segment can be mapped to or otherwise associated with structured knowledge elements of knowledge base 116.

For instance, for a logical form P(se, de), a predicate (P) can be mapped to one or more paths and/or nodes. The predicate may define a relationship between two or more entities (e.g., a source entity and a destination entity). A path that a predicate is mapped to can define a corresponding relationship between structured knowledge elements corresponding to other elements of the logical form, such as the source entity and the destination entity. For example, consider the logical form share-screen (‘actor A’, ‘actor B’). Suppose that the source entity “actor A” is mapped to structured knowledge element 502 and the predicate “share-screen” is mapped to a structured knowledge elements 512A-D. The predicate share-screen can be defined by the relationships of relevant structured knowledge elements such as node 502 and nodes representing candidate destination entities 510A-D.

FIG. 6 illustrates example, non-limiting code 600 that facilitates self-learning of rules for natural language text, in accordance with one or more embodiments described herein. Repetitive description of like elements and/or processes employed in respective embodiments is omitted for sake of brevity. As indicated previously, description relative to an embodiment of FIGS. 1-5 can be applicable to an embodiment of FIG. 6. Likewise, description relative to an embodiment of FIG. 6 can be applicable to an embodiment of FIGS. 1-5.

FIG. 6 illustrates an example training scheme for training a model to generate accurate predictions of masked elements. Updates to the rule model can maximize the score for the masked element. In an embodiment, the model can be updated based on a combined loss for each masked element. In another embodiment, the rules model can be updated based on a loss calculated for a single masked element. Any combination of losses associated with masked elements used to iteratively update a rules model is envisioned.

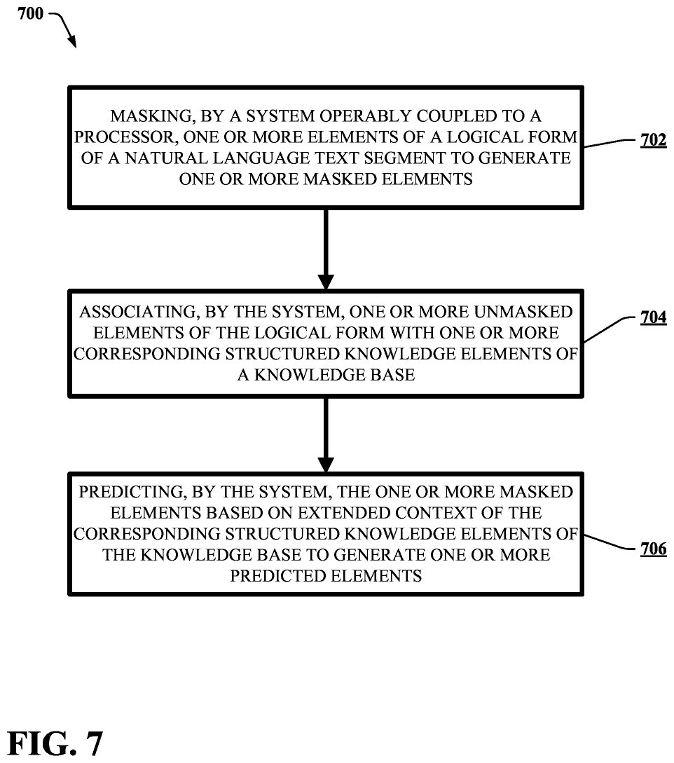

FIG. 7 illustrates a flow diagram of an example, non-limiting method 700 that can facilitate self-learning of rules for natural language text, such as in the non-limiting system 100 of FIG. 1. While the non-limiting method 700 is described relative to the non-limiting system 100 of FIG. 1, the non-limiting method 700 can be applicable also to other systems described herein. Repetitive description of like elements and/or processes employed in respective embodiments is omitted for sake of brevity. At 702, the non-limiting method 700 can comprise masking, by a system operably coupled to a processor (e.g., masking component 110), one or more elements of a logical form of a natural language text segment to generate one or more masked elements. At 704, the non-limiting method 700 can comprise associating, by the system (e.g., linking component 112), one or more unmasked elements of the logical form with one or more corresponding structured knowledge elements of a knowledge base. At 706, the non-limiting method 700 can comprise predicting, by the system (e.g., prediction component 114), the one or more masked elements based on extended context of the corresponding structured knowledge elements of the knowledge base to generate one or more predicted elements.

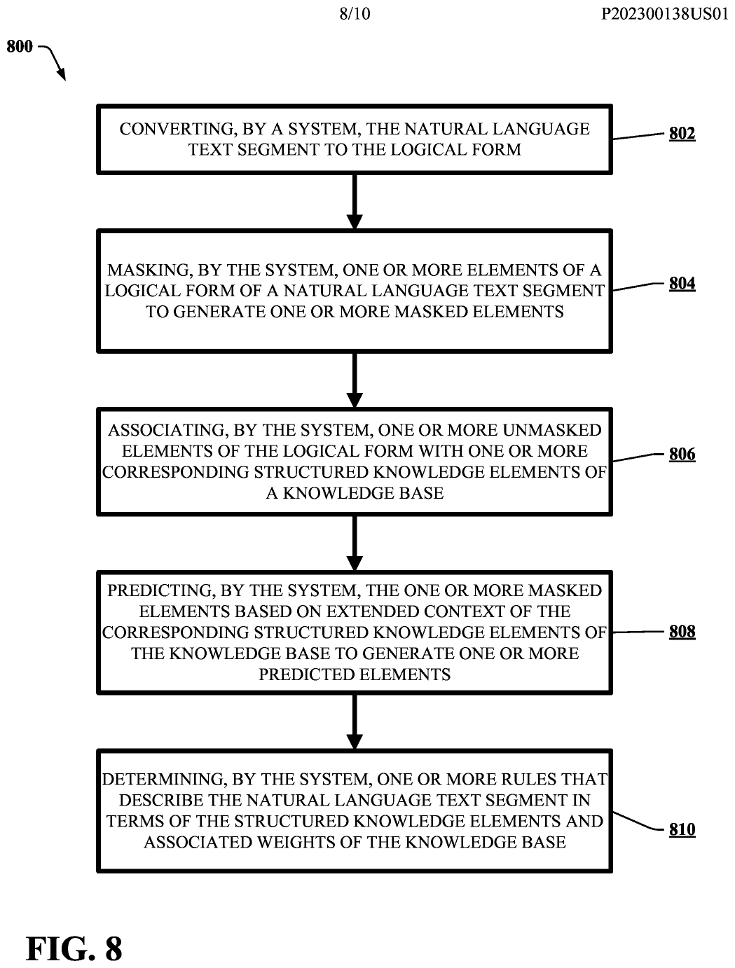

FIG. 8 illustrates a flow diagram of an example, non-limiting method 800 that can facilitate self-learning of rules for natural language text, such as in the non-limiting system 200 of FIG. 2. While the non-limiting method 800 is described relative to the non-limiting system 200 of FIG. 2, the non-limiting method 800 can be applicable also to other systems described herein. Repetitive description of like elements and/or processes employed in respective embodiments is omitted for sake of brevity. At 802, the non-limiting method 800 can comprise converting, by a system (e.g., conversion component 222), the natural language text segment to the logical form. At 804, the non-limiting method 800 can comprise masking, by the system (e.g., masking component 110), one or more elements of a logical form of a natural language text segment to generate one or more masked elements. At 806, the non-limiting method 800 can comprise associating, by the system (e.g., linking component 112), one or more unmasked elements of the logical form with one or more corresponding structured knowledge elements of a knowledge base. At 808, the non-limiting method 800 can comprise predicting, by the system (e.g., prediction component 114), the one or more masked elements based on extended context of the corresponding structured knowledge elements of the knowledge base to generate one or more predicted elements. At 810, the non-limiting method 800 can comprise determining, by the system (e.g., rules component 224), one or more rules that describe the natural language text segment in terms of the structured knowledge elements and associated weights of the knowledge base.

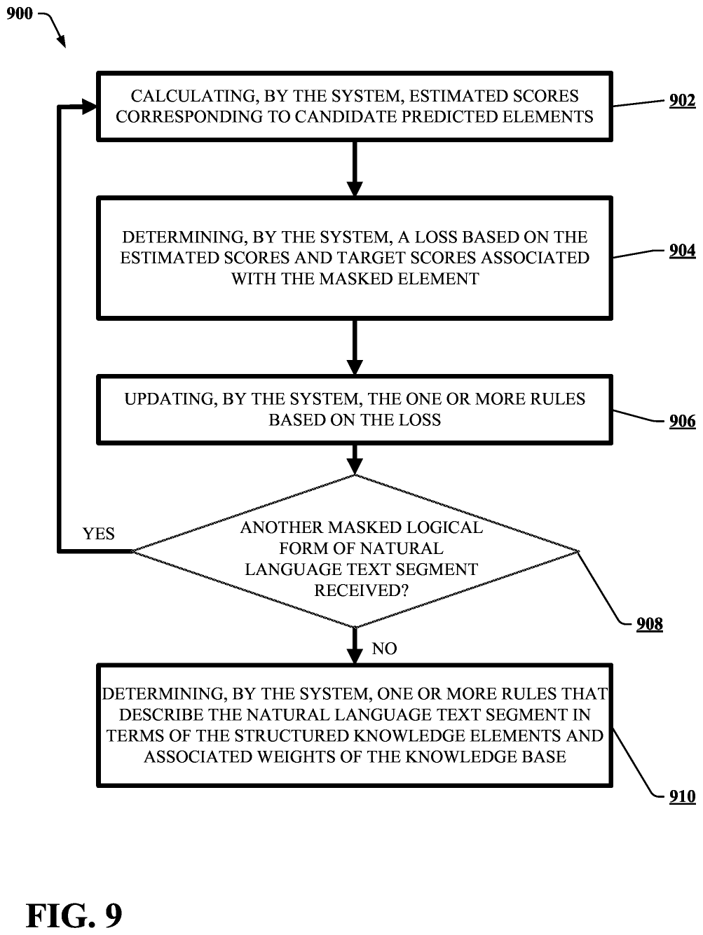

FIG. 9 illustrates a flow diagram of an example, non-limiting method 900 that can facilitate self-learning of rules for natural language text, such as in the non-limiting system 200 of FIG. 2. While the non-limiting method 900 is described relative to the non-limiting system 200 of FIG. 2, the non-limiting method 900 can be applicable also to other systems described herein. Repetitive description of like elements and/or processes employed in respective embodiments is omitted for sake of brevity. At 902, the non-limiting method 900 can comprise calculating, by the system (e.g., scoring component 118), estimated scores corresponding to candidate predicted elements. At 904, the non-limiting method 900 can comprise determining, by the system (e.g., loss component 120), a loss based on the estimated scores and target scores associated with the masked element. At 906, the non-limiting method 900 can comprise updating, by the system (e.g., rules component 224), the one or more rules based on the loss. Updating the one or more rules and/or updating a model can be iterative. At 908, the non-limiting method 900 can comprise determining, by the system whether another masked logical form of natural language text segment was received. If yes, the process flow proceeds to step 902. If no, the process flow proceeds to step 910. At 910, the non-limiting method 900 can comprise determining, by the system (e.g., rules component 224), one or more rules that describe the natural language text segment in terms of the structured knowledge elements and associated weights of the knowledge base.

Turning next to FIG. 10, a detailed description is provided of additional context for the one or more embodiments described herein at FIGS. 1-9.

FIG. 10 and the following discussion are intended to provide a brief, general description of a suitable computing environment 1100 in which one or more embodiments described herein at FIGS. 1-9 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as rule defining code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way. EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components; and
a processor that executes computer executable components stored in the memory, wherein the computer executable components comprise:
a linking component that associates one or more unmasked elements of a logical form of a natural language text segment with one or more corresponding structured knowledge elements of a knowledge base; and
a prediction component that predicts one or more masked elements of the logical form based on extended context of the one or more corresponding structured knowledge elements of the knowledge base to generate one or more predicted elements.

2. The system of claim 1, wherein the computer executable components further comprise:
a rules component that determines one or more rules that describe the natural language text segment in terms of structured knowledge elements.

3. The system of claim 1, wherein the computer executable components further comprise:
a conversion component that converts the natural language text segment to the logical form.

4. The system of claim 1, wherein computer executable components further comprise:
a masking component that masks one or more elements of the logical form of a natural language text segment resulting in the one or more masked elements and the one or more unmasked elements.

5. The system of claim 1, wherein the extended context comprises one or more candidate paths between the one or more corresponding structured knowledge elements.

6. The system of claim 1, wherein the extended context comprises one or more candidate structured knowledge elements associated with the one or more corresponding structured knowledge elements via known paths.

7. The system of claim 2, wherein the computer executable components further comprise:
a scoring component that calculates estimated scores corresponding to candidate predicted elements.

8. The system of claim 7, wherein the computer executable components further comprise:
a loss component that determines a loss based on the estimated scores and target scores associated with the one or more masked elements.

9. The system of claim 8, wherein the rules component iteratively updates the one or more rules based on the loss.

10. A computer-implemented method, comprising:
associating, by a system operably coupled to a processor, one or more unmasked elements of a logical form of a natural language text segment with one or more corresponding structured knowledge elements of a knowledge base; and
predicting, by the system, one or more masked elements of the logical form based on extended context of the one or more corresponding structured knowledge elements of the knowledge base to generate one or more predicted elements.

11. The computer-implemented method of claim 10, further comprising:
masking, by the system, one or more elements of the logical form of a natural language text segment resulting in the one or more masked elements and the one or more unmasked elements; and
determining, by the system, one or more rules that describe the natural language text segment in terms of structured knowledge elements.

12. The computer-implemented method of claim 10, wherein the extended context comprises one or more candidate paths between the one or more corresponding structured knowledge elements.

13. The computer-implemented method of claim 10, wherein the extended context comprises one or more candidate structured knowledge elements associated with the one or more corresponding structured knowledge elements via known paths.

14. The computer-implemented method of claim 11, further comprising:
calculating, by the system, estimated scores corresponding to candidate predicted elements.

15. The computer-implemented method of claim 14, further comprising:
determining, by the system, a loss based on the estimated scores and target scores associated with the one or more masked elements.

16. The computer-implemented method of claim 15, further comprising:
iteratively updating, by the system, the one or more rules based on the loss.

17. A computer program product facilitating knowledge acquisition for a knowledge base, the computer program product comprising a computer readable storage medium having program instructions embodied therewith, the program instructions executable by a processor to cause the processor to:
associate one or more unmasked elements of a logical form of a natural language text segment with one or more corresponding structured knowledge elements of the knowledge base; and
predict one or more masked elements of the logical form based on extended context of the one or more corresponding structured knowledge elements of the knowledge base to generate one or more predicted elements.

18. The computer program product of claim 17, wherein the program instructions are further executable by the processor to cause the processor to:
mask one or more elements of the logical form of a natural language text segment resulting in the one or more masked elements and the one or more unmasked elements.

19. The computer program product of claim 17, wherein the program instructions are further executable by the processor to cause the processor to:
determine one or more rules that describe the natural language text segment in terms of structured knowledge elements.

20. The computer program product of claim 19, wherein the program instructions are further executable by the processor to cause the processor to:
calculate estimated scores corresponding to candidate predicted elements.
